(19) United States
(12) Patent Application Publication
(10) Pub. No.: US 2024/0172029 A1
(43) Pub. Date: May 23, 2024

(54) Transitioning Between Pre-Configured Measurement Gap Patterns and Normal Measurement Gap Patterns

(71) Applicant: Telefonaktiebolaget LM Ericsson (PUBL), Stockholm (SE)

(72) Inventors: Iana Siomina, TÄBY (SE); Muhammad Ali Kazmi, SUNDBYBERG (SE); Joakim Axmon, LIMHAMN (SE)

(21) Appl. No.: 18/552,691

(22) PCT Filed: Mar. 31, 2022
(86) PCT No.: PCT/IB2022/053032

§ 371 Date: Sep. 27, 2023

Related U.S. Application Data
(60) Provisional application No. 63/169,300, filed on Apr. 1, 2021.

(51) Int. Cl. H04W 24/10; H04W 24/08

(52) U.S. Cl. CPC H04W 24/10; H04W 24/08

(57) ABSTRACT

A method (1000) by a wireless device (110) for transitioning between measurement gap patterns, MGPs, includes detecting (1002) a triggering event for transitioning from a first MGP to a second MGP. In response to detecting the triggering event, the wireless device maintains (1004) a first set of properties associated with the first MGP and adapts (1006) a second set of properties associated with the first MGP. The wireless device performs (1006) at least one task according to the second MGP based on the first set of properties and the second set of properties.

### TECHNICAL FIELD

The present disclosure relates, in general, to wireless communications and, more particularly, systems and methods for transitioning between pre-configured measurement gap patterns and normal measurement gap patterns.

### BACKGROUND

In New Radio (NR), the reference signal (RS) (e.g. synchronization signal block (SSB), Channel State Information-Reference Signal (CSI-RS), Positioning Reference Signal (PRS), etc.) are used by a user equipment (UE) for performing different types of measurements for different purposes such as, for example, for mobility, for Radio Link Management (RLM) related procedure, for beam management (BM) related procedure, for positioning, for scheduling and link adaptation, etc.

Mobility measurements are done on Reference Signals (RSs) of serving and neighbor cells. Examples of mobility measurements are cell detection or cell identification, signal quality, signal strength etc. Specific examples of signal strength measurements are path loss, received signal power, Reference Signal Received Power (RSRP), Synchronization Signal-Reference Signal Received Power (SS-RSRP), etc. Specific examples of signal quality measurements are received signal quality, Reference Signal Received Quality (RSRQ), Signal to Interference and Noise Ratio (SINR), Synchronization Signal-Reference Signal Received Quality (SS-RSRQ) Synchronization Signal-Signal to Interference and Noise Ratio (SS-SINR), Signal to Noise Ratio (SNR), etc. Examples of RLM related measurements are out of sync (OOS) evaluation/detection, in sync (IS) evaluation/detection, etc. Examples of BM related measurements are beam failure detection, candidate beam detection, Layer 1-Reference Signal Received Power (L1-RSRP), etc. Examples of measurements for scheduling and link adaptation are channel state information (CSI) measurements e.g. channel quality indicator (CQI), rank indicator (RI), precoding matrix indicator (PMI), etc.

In NR, as an example, the UE can be configured to perform and report measurements on one or more beams in a cell, i.e. beam level measurement. In this case, the UE may measure on a beam and transmit measurement results, which may include, for example, signal measurement (e.g. SS-RSRP) of the beam and the beam index (e.g. SSB index, CSI-RS index, etc.).

As another example, the UE can be configured to perform and report measurements on one or more cells such as, for example, a cell level measurement. In this case, the UE may measure one or more beams and derive cell level measurement results and transmit cell level measurement results, which may include, for example, signal measurement (e.g. SS-RSRP) of the cell. The beam level measurement results of one or more beams are averaged by the UE to derive the cell level measurement.

Measurement gap patterns (MGPs) are used by the UE for performing measurements on cells of the serving carriers and non-serving carriers (e.g. inter-frequency carrier, inter-Radio Access Technology (RAT) carriers, etc.). In NR, gaps are used for measurements on cells of the serving carrier in some scenarios such as, for example, if the measured signals (e.g. SSB, CSI-RS, PRS, etc.) are not fully within the active bandwidth part (BWP) of the serving cell.

The UE is scheduled in the serving cell only within the active non-dormant BWP. During a gap, the UE is generally not expected to receive and/or transmit and, therefore, cannot be scheduled in one or more serving cells. Signals for measurements may be received, however, in a serving cell for the scenarios outlined above. A measurement gap pattern is characterized or defined by several parameters: measurement gap length (MGL), measurement gap repetition period (MGRP) and measurement gap time offset with respect to some reference time (e.g., slot offset with respect to serving cell's System Frame Number (SFN) such as SFN=0). MGRP is also called as measurement gap periodicity.

FIG. 1 illustrates an example of MGP in NR. As examples, MGL can be 1.5, 3, 3.5, 4, 5.5, 6, 10, 20, etc., and MGRP can be 20, 40, 80, or 160 ms. Such type of MGP is configured by the network node upon need and will be referred further herein to as normal MGP (NMGP). Therefore, the serving base station is fully aware of the timing of each gap within such MGP. Measurement gaps may also be configured/applicable for a specific purpose, e.g., Radio Resource Management (RRM) measurements, positioning measurements, RLM, beam management, etc.

The measurement gaps can be UE specific (a.k.a. per-UE) or carrier specific (a.k.a. per-carrier). In the former case, the gaps are created on all serving cells of the UE. In the latter case, the gaps are created only on a subset of serving cells of the UE such as, for example, on serving cells operating on carriers of specific frequency range (FR). Therefore, carrier specific gaps are also called per-FR gaps such as, for example, per-FR1, per-FR2, etc.

All UEs support per-UE gaps. Whether UE supports also carrier specific or per-FR measurement gaps depends on UE capability.

A pre-configured measurement gap pattern (PMGP) refers to a type of MGP, which is pre-configured but it can be activated or deactivated based on one or more criteria or condition. For example, the PMGP is activated if the frequency of the reference signal used for measurement is within the bandwidth of the UE's active BWP; otherwise, the PMGP is deactivated (i.e., if the frequency of the reference signal used for measurement is not within the bandwidth of the UE's BWP). The PMGP can be per-UE (e.g. apply to all serving carriers in all cell groups if dual connectivity (DC) is configured), or PMGP can be per-Frequency Range (per-FR) (e.g., apply to serving carriers in the same group in DC scenario (e.g. per FR1, per FR2, etc.)). The UE may also be configured with combination of per-UE and per-FR PMGPs. The UE uses PMGP for performing certain measurements only when it is in activated state. The PMGP is not used by the UE for performing the measurements when it is in deactivated state. When PMGP is in deactivated state then the network may schedule the UE during the gaps of the PMGP enhancing end-user and system throughput.

Certain problems exist, however. For example, a UE may be capable of and configured with PMGPs and NMGPs. However, it is currently undefined when the UE should be using PMGPs (which needs to be also activated then) and when the UE should be using NMGPs and how to control the transitions between the two. Different methods of controlling transitions between the two types of MGPs will result in different amounts of signaling overhead, different network and UE performances, different times needed to perform the transitions, etc.

### SUMMARY

Certain aspects of the present disclosure and their embodiments may provide solutions to these or other challenges. For example, according to certain embodiments, methods and systems are provided to control transition between a state that uses PMGP and a state that uses NMGP. In an example scenario, the transition comprises transformation between the two types of MGP.

According to certain embodiments, a method by a wireless device for transitioning between MGPs includes detecting a triggering event for transitioning from a first MGP to a second MGP. In response to detecting the triggering event, the wireless device maintains a first set of properties associated with the first MGP and adapting a second set of properties associated with the first MGP. The wireless device performs at least one task according to the second MGP based on the first set of properties and the second set of properties.

According to certain embodiments, a wireless device for transitioning between MGPs is adapted to detect a triggering event for transitioning from a first MGP to a second MGP. In response to detecting the triggering event, the wireless device is adapted to maintain a first set of properties associated with the first MGP and adapting a second set of properties associated with the first MGP. The wireless device performs at least one task according to the second MGP based on the first set of properties and the second set of properties.

According to certain embodiments, a method by a network node for assisting a wireless device in transitioning between MGPs includes transmitting a message to a wireless device to trigger the wireless device to maintain a first set of properties associated with a first MGP and adapting a second set of properties associated with a first MGP while transitioning from the first MGP to a second MGP.

According to certain embodiments, a network node for assisting a wireless device in transitioning between MGPs is adapted to transmit a message to a wireless device to trigger the wireless device to maintain a first set of properties associated with a first MGP and adapting a second set of properties associated with a first MGP while transitioning from the first MGP to a second MGP.

According to certain embodiments, a method by a wireless device for transitioning between MGPs includes detecting a triggering event for transitioning from a first MGP to a second MGP. In response to detecting the triggering event, the wireless device ceases to use a first set of properties associated with the first MGP and initiates use of a second set of properties associated with the second MGP. The wireless device performs at least one task according to the second MGP based on the second set of properties.

According to certain embodiments, a wireless device for transitioning between MGPs is adapted to detect a triggering event for transitioning from a first MGP to a second MGP. In response to detecting the triggering event, the wireless device is adapted to cease to use a first set of properties associated with the first MGP and initiate use of a second set of properties associated with the second MGP. The wireless device is adapted to perform at least one task according to the second MGP based on the second set of properties.

According to certain embodiments, a method by a network node for assisting a wireless device in transitioning between MGPs includes transmitting a message to the wireless device to trigger the wireless device to cease using a first set of properties associated with a first MGP and initiate using of a second set of properties associated with a second MGP when transitioning from the first MGP to the second MGP.

According to certain embodiments, a network node for assisting a wireless device in transitioning between MGPs is adapted to transmit a message to the wireless device to trigger the wireless device to cease using a first set of properties associated with a first MGP and initiate using of a second set of properties associated with a second MGP when transitioning from the first MGP to the second MGP.

Certain embodiments may provide one or more of the following technical advantages. For example, one technical advantage may be that certain embodiments reduce signaling overhead. As another example, a technical advantage may be that certain embodiments provide a possibility of faster transition between an old MGP and a new MGP. As still another example, a technical advantage may be that certain embodiments reduce scheduling impact. As yet another example, a technical advantage may be that certain embodiments reduce data transmission/reception impact.

Other advantages may be readily apparent to one having skill in the art. Certain embodiments may have none, some, or all of the recited advantages.

### BRIEF DESCRIPTION OF DRAWINGS

For a more complete understanding of the disclosed embodiments and their features and advantages, reference is now made to the following description, taken in conjunction with the accompanying drawings, in which:

FIG. 1 illustrates an example of Measurement Gap Pattern (MGP) in New Radio (NR);

FIG. 2 illustrates an example of pre-configured measurement gap pattern (PMGP);

FIG. 3 illustrates an example wireless network, according to certain embodiments;

FIG. 4 illustrates an example network node, according to certain embodiments;

FIG. 5 illustrates an example wireless device, according to certain embodiments;

FIG. 6 illustrate an example user equipment, according to certain embodiments;

FIG. 7 illustrates a virtualization environment in which functions implemented by some embodiments may be virtualized, according to certain embodiments;

FIG. 8 illustrates a telecommunication network connected via an intermediate network to a host computer, according to certain embodiments;

FIG. 9 illustrates a generalized block diagram of a host computer communicating via a base station with a user equipment over a partially wireless connection, according to certain embodiments;

FIG. 10 illustrates a method implemented in a communication system, according to one embodiment;

FIG. 11 illustrates another method implemented in a communication system, according to one embodiment;

FIG. 12 illustrates another method implemented in a communication system, according to one embodiment;

FIG. 13 illustrates another method implemented in a communication system, according to one embodiment;

FIG. 14 illustrates an example method by a wireless device, according to certain embodiments;

FIG. 15 illustrates an example virtual apparatus, according to certain embodiments;

FIG. 16 illustrates an example method by a network node, according to certain embodiments;

FIG. 17 illustrates another example virtual apparatus, according to certain embodiments;

FIG. 18 illustrates another example method by a wireless device, according to certain embodiments;

FIG. 19 illustrates another example virtual apparatus, according to certain embodiments;

FIG. 20 illustrates another example method by a network node, according to certain embodiments; and

FIG. 21 illustrates another example virtual apparatus, according to certain embodiments.

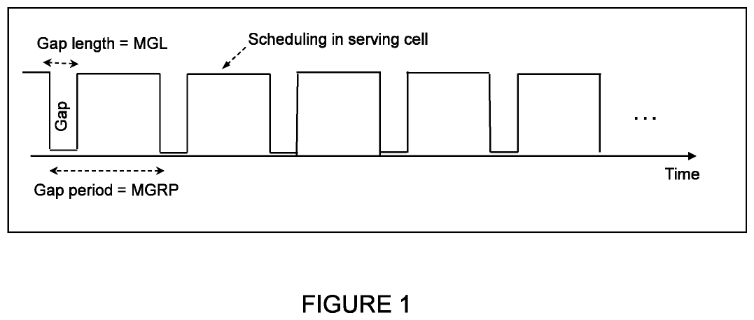

### DETAILED DISCLOSURE

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, Master eNodeB (MeNB), a network node belonging to Master Cell Group (MCG) or Secondary Cell Group (SCG), base station (BS), multi-standard radio (MSR) radio node such as MSR BS, eNodeB (cNB), secondary eNodeB (SeNB), gNodeB (gNB), location measurement unit (LMU), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN access point, access point (AP), transmission points, transmission nodes, transmission reception point (TRP), Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Optimizing Node (SON), positioning node (e.g., Evolved Serving Mobile Location Center (E-SMLC), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Digital Assistant (PDA), Tablet, mobile terminals, smart phone, laptop embedded equipped (LEE), laptop mounted equipment (LME), Unified Serial Bus (USB) dongles, UE category M1, UE category M2, Proximity Services (ProSe) UE, Vehicle-to-Vehicle (V2V) UE, Vehicle-to-Anything (V2X) UE, etc.

Additionally, terminologies such as base station/gNB and UE should be considered non-limiting and do in particular not imply a certain hierarchical relation between the two; in general, “gNB” could be considered as device 1 and “UE” could be considered as device 2 and these two devices communicate with each other over some radio channel. And in the following the transmitter or receiver could be either gNB, or UE.

The term radio access technology, or RAT, may refer to any RAT such as, for example, Universal Terrestrial Radio Access (UTRA), Evolved UTRA (E-UTRA), narrow band internet of things (NB-IOT), WiFi, Bluetooth, next generation RAT (NG-RAT), New Radio (NR), 4th Generation (4G), 5th Generation (5G), etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as primary synchronization signal (PSS), secondary synchronization signal (SSS), channel state information-reference signal (CSI-RS), Demodulation Reference Signal (DMRS) signals in SS/PBCH block (SSB), discovery reference signal (DRS), cell reference signal (CRS), positioning reference signal (PRS), etc. RS may be periodic, e.g. RS occasion carrying one or more RSs may occur with certain periodicity, e.g. 20 ms, 40 ms etc. The RS may also be aperiodic. Each Synchronization Signal Block (SSB) carries New Radio-Primary Synchronization Signal (NR-PSS), New Radio-Secondary Synchronization Signal (NR-SSS) and New Radio-Physical Broadcast Channel (NR-PBCH) in four successive symbols. One or multiple SSBs are transmit in one SSB burst which is repeated with certain periodicity such as, for example, 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g. serving cell's SFN) etc. Therefore, SMTC occasion may also occur with certain periodicity such as, for example, 5 ms, 10 ms, 20 ms, 40 ms, 80 ms and 160 ms. Examples of uplink (UL) physical signals are reference signal such as Sounding Reference Signal (SRS), Demodulation Reference Signal (DMRS), etc. The term physical channel refers to any channel carrying higher layer information such as, for example, data, control information, etc. Examples of physical channels are Physical Broadcast Channel (PBCH), Narrowband PBCH (NPBCH), Physical Downlink Control Channel (PDCCH), Physical Downlink Shared Channel (PDSCH), short Physical Uplink Control Channel (sPUCCH), short PDSCH (SPDSCH), short PUSCH (sPUSCH), machine PDCCH (MPDCCH), Narrowband PDCCH (NPDCCH), Narrowband PDSCH (NPDSCH), Enhanced PDCCH (E-PDCCH), Physical Uplink Shared Channel (PUSCH), Physical Uplink Control Channel (PUCCH), Narrowband PUSCH (NPUSCH), etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, etc.

A generic term active Bandwidth Part (BWP) switching used here refer to switching between any two BWPs in downlink (DL) and/or in uplink (UL) of a serving cell. The active BWP switching may also comprise switching between non-dormant BWP and dormant BWP on a serving cell, e.g. SCell. In a serving cell with dormant BWP, the UE is not expected to monitor the control channels but only performs measurements, e.g. RRM, CSI, etc. In non-dormant BWP, the UE is expected to monitor the control channels as well as perform other tasks, e.g. perform measurements. The active BWP switching may also be called as active BWP change, active BWP modification, or simply BWP switching.

The NMGP may also be called as legacy MGP, existing MGP, non-PMGP, MGP which is not PMGP etc.

A measurement gap or a measurement gap instance within a measurement gap pattern (MGP) (e.g. PMGP or NMGP) may be defined as:
In an example, a gap in the MGP may be a time period during which the UE is not required to conduct reception/transmission from/to the corresponding serving cell except the reception of signals used for measurement. In another example, a gap in the MGP may be a time period during which the UE is not required to conduct reception/transmission from/to the corresponding serving cell except the reception of signals used for measurement and/or signals used for random access procedure. In another example a gap in the per-UE MGP may be a time period during which the UE is not required to conduct reception/transmission from/to the corresponding NR serving cells except the reception of signals used for RRM measurement(s), PRS measurement(s) and the signals used for random access procedure. In another example a gap in the per-FR MGP may be a time period during which the UE is not required to conduct reception/transmission from/to the corresponding NR serving cells in the corresponding frequency range except the reception of signals used for RRM measurement(s), PRS measurement(s) and the signals used for random access procedure.

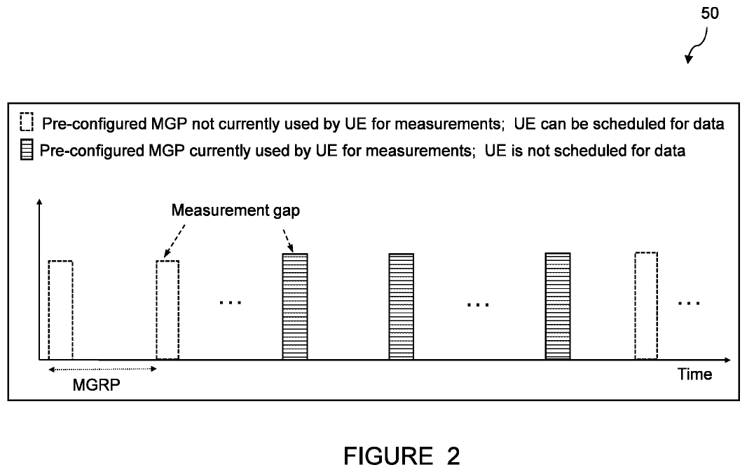

FIG. 2 illustrates an example of pre-configured measurement gap pattern (PMGP) 50, which a wireless device such as, for example, a UE, may not use for measurements all of the time. The UE may be scheduled during gaps when PMGP is not used.

According to certain embodiments, a UE is configured with one or more PMGP by the network, e.g., via RRC. In some, but not all, embodiments, the UE is also configured with one or more NMGPs, e.g., via RRC. The methods described herein may be related to two different scenarios and are described in more detail below.

As used below, the term “using an MGP” (e.g., PMGP or NMGP) comprises at least receiving/transmitting signals and channel according to the MGP (including receiving during measurement gaps the measured signals while maintaining the allowed amount of interruptions in other (e.g., data) transmissions/receptions in the serving cells, etc.). It can further comprise activating MGP (in case of starting to use the MGP) or deactivating MGP (in case of stopping to use the MGP).

Methods to Control the Transition which is Based on MGP Transformation

In a first scenario (Scenario 1), a UE or other wireless device transitions between State 1A and State 1B (i.e., in either direction) based on MGP transformation (PMGP to NMGP and/or NMGP to PMGP). In this example, State 1A comprises UE using PMGP, and State 1B comprises UE using NMGP. The transformation means inheriting at least some properties P1 (e.g., MGL, MGRP, offset, etc.) of the original MGP but changing other properties P2 (e.g., related to scheduling during gaps). It may be noted that, in an extension of Scenario 1, the UE may also be configured with one or more other MGPs in either one or both of State 1A and State 1B, but the transformation applies between at least one pair of PMGP and NMGP.

According to certain embodiments, at transition in Scenario 1, the UE adapts the set of properties P2 to become the P2 of the new state (which is State 1B if the transition is from State 1A to 1B, or State 1A if the transition is from State 1B to 1A). The advantage is a simpler and faster procedure, with less signaling overhead, avoiding the need to configure a new MGP from scratch or deconfigure/deactivate the current pattern. The advantage is even more pronounced in case multiple transitions are needed.

In a particular embodiment, for example, the set of properties P2 of PMGP allows for scheduling the UE during its measurement gaps when UE is not using PMGP such as, for example, when the frequency or bandwidth of the reference signal (RS) (e.g., SSB) is within the frequency or bandwidth of the UE's active BWP, while P2 of NMGP is characterized with that there is no scheduling of the UE during its measurement gaps.

In a particular embodiment of Scenario 1, the UE can be configured with one MGP, since PMGP and NMGP can reuse the set of properties P1, and then the transformation is triggered upon the need to adapt the set of properties P2.

According to certain embodiments, after the transition of the MGP, such as, for example, from PMGP to NMGP or vice versa, the UE starts using the MGP for one or more tasks such as measurements, receiving scheduling in gaps of PMGP when they are not used for measurements, etc.

According to various embodiments, the transition triggers between State 1A and State 1B (in one or both directions) can be, for example, by a message from another node, a rule, an event, one or more conditions, any one or any combination of the below can apply:
In a particular embodiment, the transition in at least one direction can be triggered by an indication or message (e.g., downlink control information (DCI), radio resource control (RRC) message, or Medium Access Control (MAC) command) received from another node (e.g., network node). This is explained with few examples:
   In one example, the network may determine that the bandwidth (BW) of the RS for measurements will be in the BW of the UE's active BWP over the next certain time period (e.g. X1 seconds, X2 number of DRX cycles, X3 number of SFN cycles, etc.). In this case, the network may send an indicator to the UE requesting it to transform the already configured NMGP to PMGP.
   In another example, the network may determine that the data in the UE buffer is below certain threshold, e.g. small amount of data. In this case, the network may send an indicator to the UE requesting it to transform the already configured PMGP to NMGP since the UE is not expected to be scheduled so often.
In a particular embodiment, the transition is triggered based on one or more parameter received in a message (e.g., dedicated message, broadcast or multicast, system information, etc.) from another node (e.g., gNB or LMF). The message can be DCI, RRC message, or MAC command, as examples.
   In one example, a UE receives a threshold that can be further used in determining whether the transition is triggered or not (e.g., triggered if the threshold is exceeded, etc.), so the decision is made in the UE based on the comparison with respect to the threshold while the parameter/threshold is controlled by a network node.
   In another example, the parameter indicates a configuration (e.g., purpose, type, a parameter value, etc.) of a signal, measurement, procedure, which, if configured in the UE, becomes a trigger for the transition.
   The parameter can be related to a signal type or characteristic, measurement type or characteristic, activity/inactivity level (e.g., DRX configuration), data traffic availability/amount/activity, timing parameter or timer configuration indicative of when the transition to occur, time to be spent in a state after the transition, the number or the set of frequencies or RATs relevant for one or another set (e.g., if a certain RAT or a certain number of frequencies or frequencies from a specific range are configured the transition is triggered), etc.
In a particular embodiment, the transition is timer-triggered. For example, the timer may start upon a condition, event, or upon entering one of the states where the UE can spend a certain time (controlled by the timer). Alternatively, upon the timer expiration, the UE may transition to the other state. The timer can be pre-defined or configured by the network node. The timer value can be the same or it can be different for different transition directions such as, for example, timer value Tx1 for transition from PMGP to NMGP and Tx2 for transition from NMGP to PMGP. For example, in a particular embodiment, the timer starts when the PMGP is configured and upon its expiry the PMGP is transformed to NMGP.
In a particular embodiment, the transition is triggered when the UE is configured or deconfigured with certain number, N (e.g., N=1, 2, . . . ), carrier frequencies for measurements for which it always needs measurement gaps (e.g., the former (i.e. when carrier always needs gaps is configured) can trigger the transition from PMGP to NMGP, the latter (i.e. when carrier always need gaps is deconfigured) can trigger the transition from NMGP to PMGP)
   The carrier frequencies can be, for example, any one or more of: inter-RAT, inter-frequency, and positioning frequency layers. For example measurement on inter-RAT carrier (e.g. LTE) may always need gaps and therefore when LTE measurement is configured then the PMGP is transformed to NMGP.
In a particular embodiment, the transition is triggered when measurements on a carrier frequency from a certain frequency range (FR) are configured
In a particular embodiment, the transition is triggered when measurements in a certain RAT are configured
In a particular embodiment, the transition is triggered when the UE is configured with measurements on reference signals (e.g., based on SSB or CSI-RS or PRS) whose frequency or BW is outside the BW or frequency of the UE's active BWP
In a particular embodiment, the transition is triggered when the UE is configured with measurements based on a specific type of signals (e.g., PRS) and/or for a specific purpose (e.g., positioning). For example, assume that the UE needs gaps for PRS measurements. When the UE is configured to perform measurement (e.g. RSTD, PRS-RSRP, UE Rx-Tx time difference etc.) on PRS, then the UE may be configured to transform the PMGP to NMGP.
In a particular embodiment, the transition is triggered depending on additional conditions, such as, for example:
   Related to periodicity, e.g.:
      “Aperiodic (as a special periodicity configuration case) or event-triggered measurements may not trigger the transition, while the transition can be triggered for periodic and/or semi-persistent measurements.
      ” Measurements with shorter periodicity (MGRP<threshold) have a more significant impact on scheduling, so PMGP may be preferred (so a transition from NMGP to PMGP can be triggered if the condition (MGRP<threshold) is met); otherwise the NMGP is not transformed to PMGP and the UE continues using the MGP as NMGP.
   Related to UE activity level, e.g.:
      PMGP can be more motivated to use when the UE is in DRX or with DRX cycle/period length>threshold (so a transition from NMGP to PMGP can be triggered if the condition (e.g. DRX cycle is above threshold) is met); otherwise the NMGP is not transformed to PMGP and the UE continues using the MGP as NMGP.
   Related to similarity of PMGP and NMGP, e.g.:
      If NMGP configuration is similar (e.g., at least a certain set of parameters and properties is the same, etc.) to PMGP, then the transformation may not be needed; otherwise the transformation can be triggered if the parameters is properties of the other MGP is better suited for the measurements (including MGL, MGRP, offset, which determine time alignment with measured signals, etc.), e.g.:
         transition can be triggered to the MGP with the MGL, MGRP, offset, etc. which are better aligned with the signals to measure so that measurement gaps are not wasted (contain the signals to measure) and have sufficient overlap with the signals to contain enough slots or symbols with the required signals etc.

In a particular embodiment, based on one or more of the above, the UE can determine the need to transition from State 1A to State 1B or from State 1B to State 1A.

In another embodiment, the UE can also determine the time when it needs to transition or start using the MGP of the new state it transitioned to. To determine the time, the UE may need to further obtain some timing information and reference time. For example, the UE shall be able to use the MGP of the new state after a pre-defined time after receiving a message or after the transition triggering time point. In another example, the UE shall be able to use the MGP of the new state at the first MGP occasion after the transition to the new state is complete. In one example the timing information may comprise for example SFN of frame in which the UE starts the MGP after the transition. In another example, the timing information may comprise, for example, SFN of frame and the gapoffset. As an example, the UE starts the MGP after the transition at the first subframe of the indicated SFN that meets the following condition:
SFN mod T=FLOOR(gapOffset/10)
subframe=gapOffset mod 10
with T=MGRP/10

In a further embodiment, the UE can also determine the time until when or for how long it can stay in the new state or can use the MGP of the new state. In one example, the UE can remain in the new state for a pre-defined amount of time or for an amount of time configured by another node. In another example, the UE will monitor an event or condition or whether a rule is fulfilled to determine whether it is time to perform the transition back. In yet another example, the UE can stay in the new state until an event occurs or condition or rule is fulfilled but no longer than a pre-defined or configured amount of time, i.e., whichever comes first. The length of time in which the UE stays in a state (e.g. use MGP as PMGP or as NMGP) can be expressed in any time unit (e.g. Y1 seconds) or in certain number of time resources (e.g. Y2 frames, Y3 SFN cycles (hyperframes), Y4 subframes, Y5 MGRPs, Y6 DRX cycles, etc.).

Methods to Control the Transition which is Based on MGP Switching
In a second scenario (Scenario 2), a UE or other wireless device transitions between State 2A and State 2B (i.e., in either direction) based on MGP switching (PMGP to NMGP and/or NMGP to PMGP). In this scenario, State 2A comprises UE using PMGP, and State 2B comprises UE using NMGP. The transformation means the UE starts using the MGP of the new state and stops using the MGP of the original state. It may be noted that, in an extension of Scenario 2, the UE may also be configured with one or more other MGPs in either one or both of State 2A and State 2B, but the transformation applies between at least one pair of PMGP and NMGP.

In a particular embodiment of Scenario 2, the UE can be configured with both PMGP and NMGP, but it can use only one of them at a time while switching between the states, and which MGP is used determines whether the UE is in State 2A or 2B.

Which one of the plurality of the MGPs to be used after the transition can be further determined by one or more rule which can be pre-defined or configured by the network node. The rule may further depends on one or more parameters related to MGP configuration (e.g. MGRP, etc.) and/or one or more parameters related to measurement configuration (e.g. DRX cycle, type of measurement, type of RS used for measurement, etc.). The UE may also be indicated in a message (e.g. DCI, MAC-CE. RRC, etc.) about the MGP to be used by the UE for doing the measurements after the transition. In one example of the rule, the MGP which is transformed is used for further measurements while the MGP which was not transformed is not used for measurements. In another example of the rule, the MGP that is transformed is not used for further measurements while the MGP which was not transformed is used for further measurements. For example assume that the UE is configured with one PMGP (PMGP1) and one NMGP (NMGP1). The PMGP1 is transformed to NMGP (e.g. called here as NMGP2). After the transition, the UE is configured with two NMGP patterns (NMGP1 and NMGP2) and no PMGP. In one example, after the transition, the UE starts using NMGP2 for the measurements and does not use NMGP1 anymore until, for example, the next transition or indication. In another example, after the transition, the UE may use the MGP based on MGRP of two or more MGPs. Assume two MGPs (e.g. NMGP1 and NMGP2) after the transition with MGRP1=40 ms and MGRP2=160 ms. In one specific example, the UE selects and uses the MGP (e.g. NMGP1) with shortest MGRP (MGRP1 e.g. 40 ms) after the transition. In another specific example, the UE selects and uses the MGP (e.g. NMGP2) with largest MGRP (MGRP1 e.g. 160 ms) after the transition.

In another example of the rule upon transition from one state to another state, at least one of the MGPs of the same type (e.g. PMGP) may be deconfigured (e.g. regarded as invalid, released, or cancelled) and the UE may use only the MGP which is configured (e.g. valid, allowed, etc.). This rule may further depend on one or more parameters related to MGP configuration (e.g. MGRP, etc.) and/or one or more parameters related to measurement configuration (e.g. DRX cycle, type of measurement, type of RS used for measurement, etc.). The rule can be pre-defined or configured by the network node. The UE may also be indicated in a message (e.g. DCI, MAC-CE, RRC, etc.) about the MGP to be used by the UE for doing the measurements after the transition and/or which one of the MGPs is to be deconfigured at or after the transition. In one example, the UE may cancel or deconfigure the MGP which is not transformed. In another example, the UE may cancel or deconfigure the MGP which is transformed. For example, assume that the UE is configured with one PMGP (PMGP1) and one NMGP (NMGP1). The PMGP1 is transformed to NMGP (e.g. called here as NMGP2). In one example, after or at the transition, the UE deconfigures or cancels NMGP1 and use NMGP2 for doing the measurements. In another example of the rule, after the transition, the UE may use the MGP based on MGRP of two or more MGPs and deconfigures the other MGPs. Assume here also there will be two MGPs (e.g. NMGP1 and NMGP2) after the transition with MGRP1=40 ms and MGRP2=160 ms. In one specific example, the UE selects and uses the MGP (e.g. NMGP1) with shortest MGRP (e.g. MGRP1) and deconfigures the other MGP (e.g. NMGP2) with larger MGRP (e.g. MGRP2) after the transition. In another specific example, the UE selects and uses the MGP with largest MGRP and deconfigures the MGPs with smaller MGRP after the transition.

The transition triggers between State 2A and State 2B (in one or both directions) can be, for example, by a message from another node, a rule, an event, one or more conditions. The same transition triggers described above with regard to Scenario 1 can also be used here.

In a particular embodiment, based on one or more of the transition triggers, the UE can determine the need to transition from State 2A to State 2B or from State 2B to State 2A.

In another embodiment, the UE can also determine the time when it needs to transition or start using the MGP of the new state it transitioned to. Again, the same methods to determine the time as described above with regard to Scenario 1 can also be used here.

In a further embodiment, the UE can also determine the time until when or for how long it can stay in the new state or can use the MGP of the new state. Again, the methods described for determining the time can also be used here.

Herein, it is assumed that the UE can trigger transition depending on UE capability related to concurrent measurement gaps.

In one example, the UE can support up to K number of MGPs concurrently (e.g., in total or the number of PMGPs or the number of NMGPs), and if the UE needs a MGP of a certain type (PMGP or NMGP) then it can configure and start using it if the capability K is not exceeded, otherwise either methods in section 6.3 or methods in section 6.4 are applied.

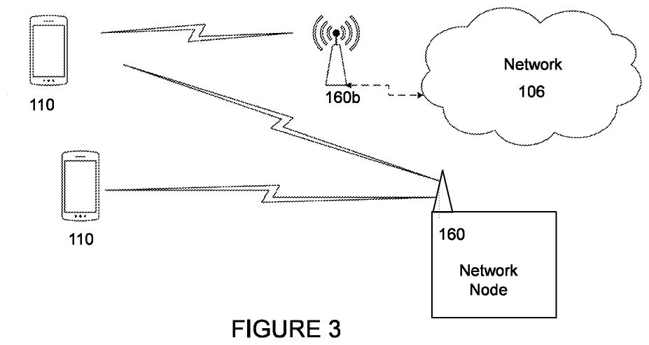

FIG. 3 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 3. For simplicity, the wireless network of FIG. 3 only depicts network 106, network nodes 160 and 160b, and wireless devices 110. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

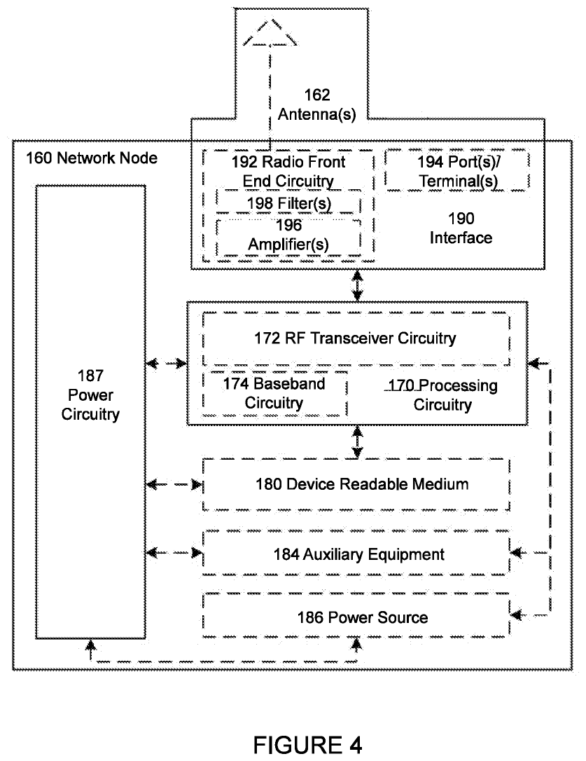

FIG. 4 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

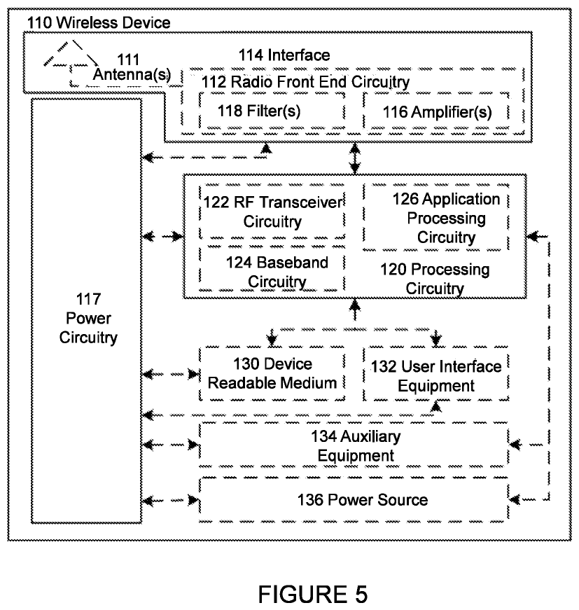

FIG. 5 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IOT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR. WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used, wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

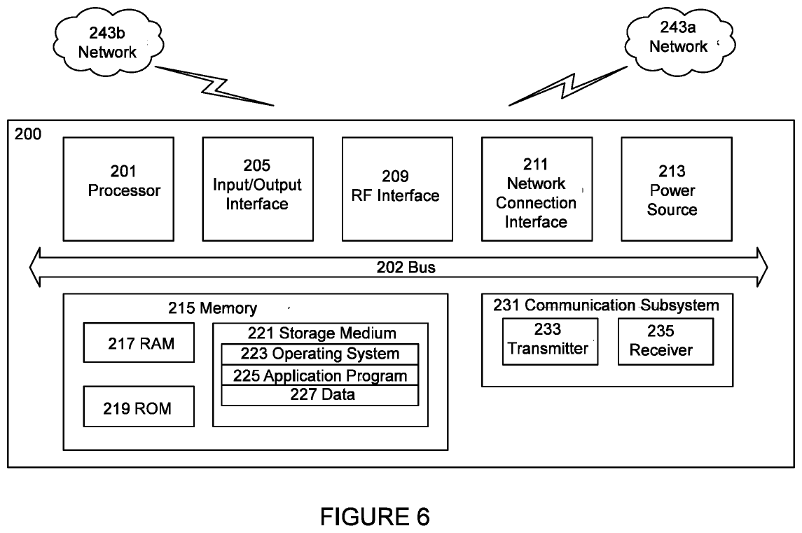

FIG. 6 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3rd Generation Partnership Project (3GPP), including a NB-IOT UE, a machine type communication (MTC) UE, and/or an enhanced MTC (eMTC) UE. UE 200, as illustrated in FIG. 4, is one example of a wireless device configured for communication in accordance with one or more communication standards promulgated by the 3rd Generation Partnership Project (3GPP), such as 3GPP's GSM, UMTS, LTE, and/or 5G standards. As mentioned previously, the term wireless device and UE may be used interchangeable. Accordingly, although FIG. 6 is a UE, the components discussed herein are equally applicable to a wireless device, and vice-versa.

In FIG. 6, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 6, or only a subset of the components. The level of integration between the components may vary from one UE to another UE. Further, certain UEs may contain multiple instances of a component, such as multiple processors, memories, transceivers, transmitters, receivers, etc.

In FIG. 6, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 6, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 6, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

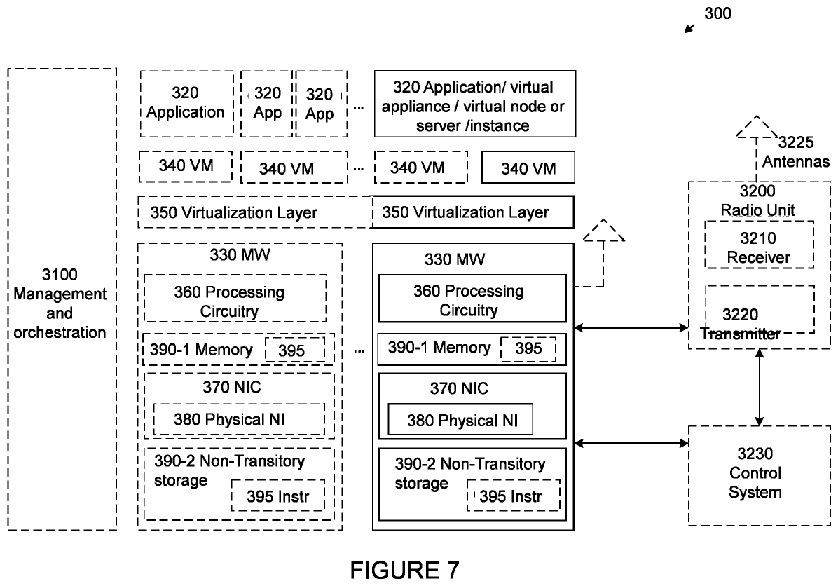

FIG. 7 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 7, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 7.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

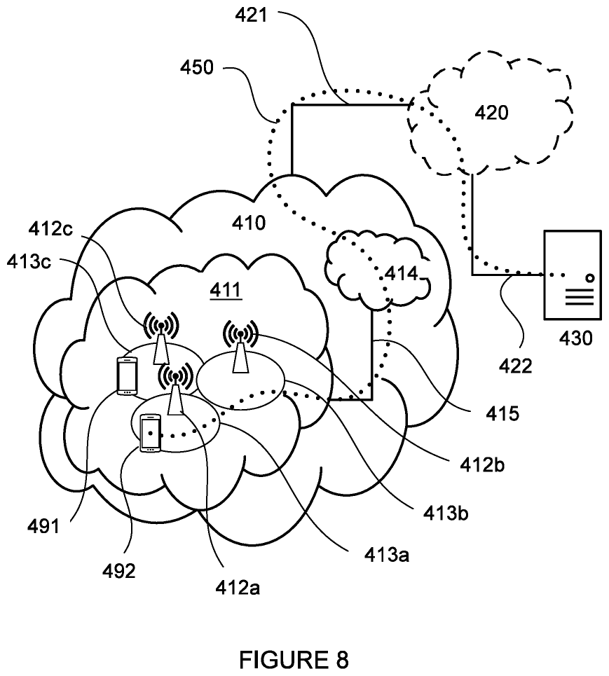

FIG. 8 illustrates a telecommunication network connected via an intermediate network to a host computer in accordance with some embodiments.

With reference to FIG. 8, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 8 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

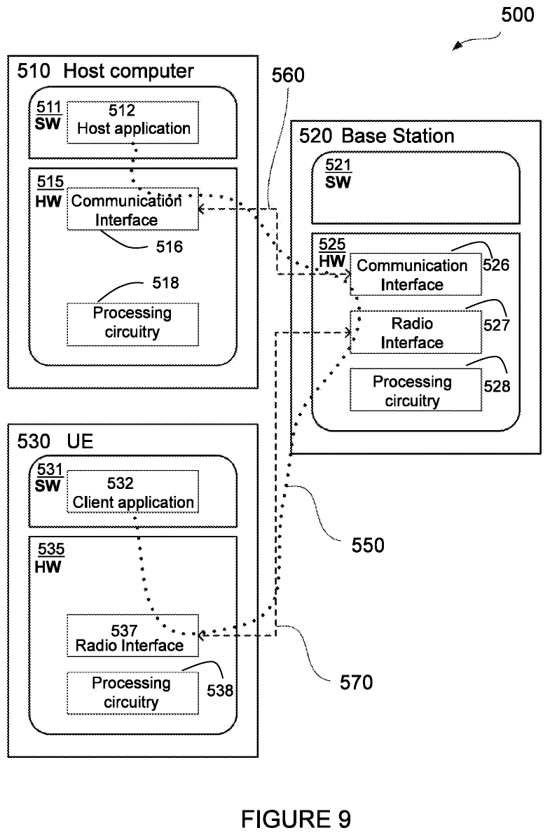

FIG. 9 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 9. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 9) served by base station 520. Communication interface 526 may be configured to facilitate connection 560 to host computer 510. Connection 560 may be direct or it may pass through a core network (not shown in FIG. 9) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 9 may be similar or identical to host computer 430, one of base stations 412a, 412b, 412c and one of UEs 491, 492 of FIG. 8, respectively. This is to say, the inner workings of these entities may be as shown in FIG. 9 and independently, the surrounding network topology may be that of FIG. 8.

In FIG. 9, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

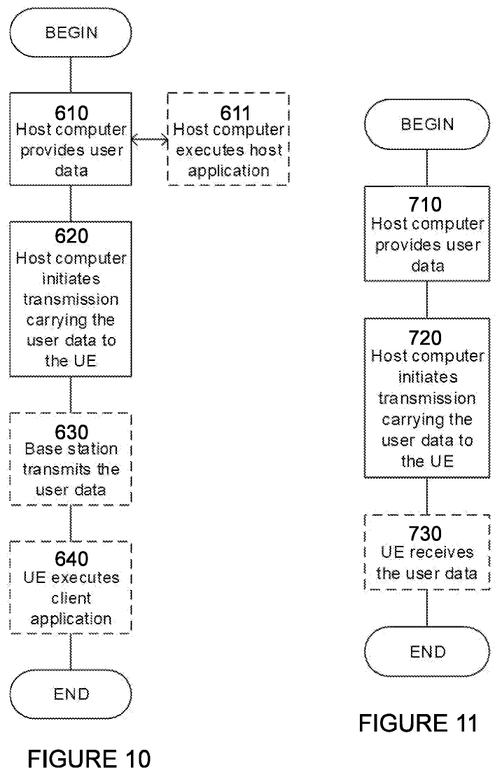

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

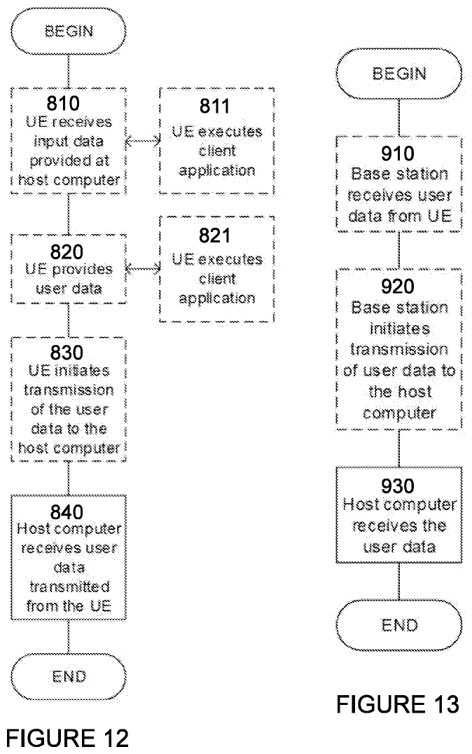

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

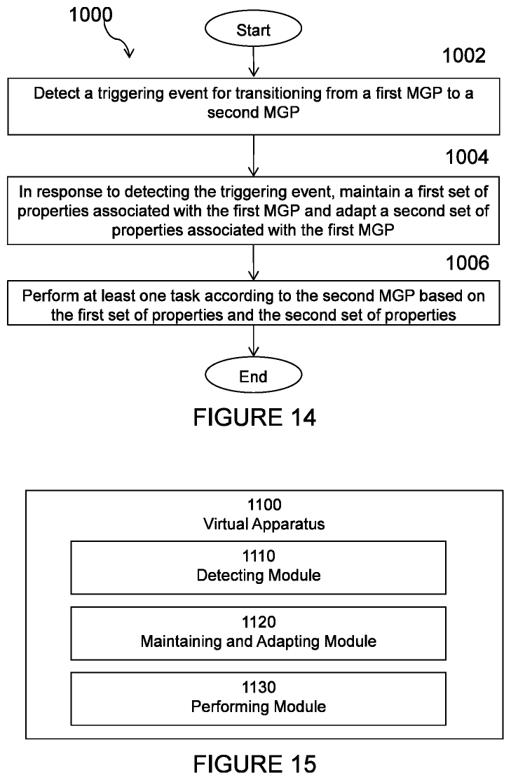

FIG. 14 depicts a method 1000 by a wireless device 110 for transitioning between MGPs, according to certain embodiments. At step 1002, the wireless device 110 detects a triggering event for transitioning from a first MGP to a second MGP. At step 1004, in response to detecting the triggering event, the wireless device 110 maintains a first set of properties associated with the first MGP and adapts a second set of properties associated with the first MGP. At step 1006, the wireless device 110 performs at least one task according to the second MGP based on the first set of properties and the second set of properties.

In a particular embodiment, the first MGP comprises a PMGP and the second MGP comprises a NMGP or the first MGP comprises a NMGP and the second MGP comprises a PMGP.

In a particular embodiment, the second set of properties comprises a property or parameter associated with scheduling during measurement gaps.

In a particular embodiment, the first set of properties comprises any one or more of: a property associated with a measurement gap length, MGL, a property associated with a measurement gap repetition period, MGRP, and a property associated with an offset.

In a particular embodiment, maintaining the first set of properties associated with the first MGP comprises reusing the first set of properties while performing the at least one task according to the second MGP.

In a particular embodiment, performing the at least one task comprises at least one of: performing at least one measurement during a measurement gap according to the second MGP, and receiving scheduling during a measurement gap of the second MGP when the measurement gap is not used for measurements.

In a particular embodiment, detecting the triggering event for transitioning from the first MGP to the second MGP comprises receiving at least one message from a network node.

In a particular embodiment, the at least one message comprises at least one of: a configuration of a signal, a measurement or measurement type, a procedure, a characteristic of a signal or a measurement, an activity or inactivity level, a characteristic associated with a traffic level, and a timing parameter.

In a particular embodiment, detecting the triggering event for transitioning from the first MGP to the second MGP comprises at least one of: detecting a configuration for measurements in a radio access technology; detecting a configuration or deconfiguration of a number of carrier frequencies for performance of measurements; detecting a configuration for measurements on at least one reference signal; and detecting a configuration for measurements on a type of reference signal.

In various particular embodiments, the method may additionally or alternatively include one or more of the steps or features of the Group A and Group E Example Embodiments described below.

FIG. 15 illustrates a schematic block diagram of a virtual apparatus 1100 in a wireless network (for example, the wireless network shown in FIG. 3). The apparatus may be implemented in a wireless device or network node (e.g., wireless device 110 or network node 160 shown in FIG. 3). Apparatus 1100 is operable to carry out the example method described with reference to FIG. 14 and possibly any other processes or methods disclosed herein. It is also to be understood that the method of FIG. 14 is not necessarily carried out solely by apparatus 1100. At least some operations of the method can be performed by one or more other entities.

Virtual Apparatus 1100 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause determining module 1110, maintaining and adapting module 1120, performing module 1130, and any other suitable units of apparatus 1100 to perform corresponding functions according one or more embodiments of the present disclosure.

According to certain embodiments, detecting module 1110 may perform certain of the detecting functions of the apparatus 1100. For example, detecting module 1110 may detect a triggering event for transitioning from a first MGP to a second MGP.

According to certain embodiments, maintaining and adapting module 1120 may perform certain of the maintaining and/or adapting functions of the apparatus 1100. For example, in response to detecting the triggering event, maintaining and adapting module 1120 may maintain a first set of properties associated with the first MGP and adapt a second set of properties associated with the first MGP.

According to certain embodiments, performing module 1120 may perform certain of the performing functions of the apparatus 1100. For example, performing module 1120 may perform at least one task according to the second MGP based on the first set of properties and the second set of properties.

Optionally, in particular embodiments, virtual apparatus may additionally include one or more modules for performing any of the steps or providing any of the features in the Group A and Group E Example Embodiments described below.

As used herein, the term module or unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

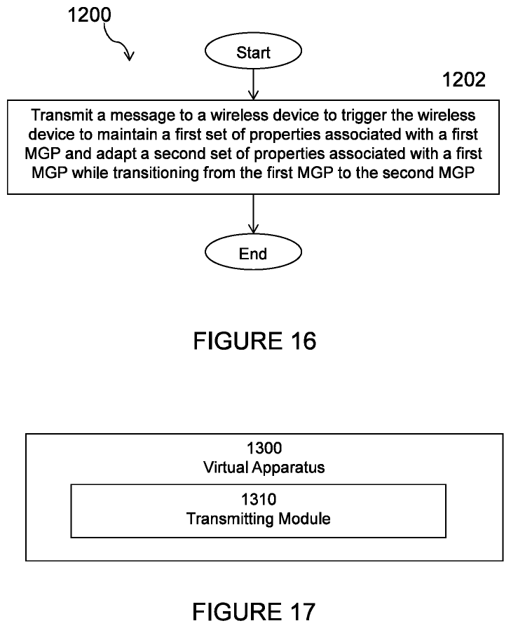

FIG. 16 depicts a method 1200 by a network node 160 for assisting a wireless device 110 in transitioning between MGPs, according to certain embodiments. At step 1202, the network node 160 transmits a message to a wireless device 110 to trigger the wireless device 110 to maintain a first set of properties associated with a first MGP and adapting a second set of properties associated with a first MGP while transitioning from the first MGP to a second MGP.

In a particular embodiment, the first MGP comprises a Predefined MGP. PMGP, and the second MGP comprises a normal MGP, NMGP, or the first MGP comprises a NMGP and the second MGP comprises a PMGP.

In a particular embodiment, the second set of properties comprises a property or parameter associated with scheduling during measurement gaps.

In a particular embodiment, the first set of properties comprises any one or more of: a property associated with a measurement gap length, MGL, a property associated with a measurement gap repetition period, MGRP, and a property associated with an offset.

In a particular embodiment, the message indicates or triggers the wireless device to reuse the first set of properties while performing the at least one task according to the second MGP.

In a particular embodiment, the network node 160 further transmits scheduling during a measurement gap of the second MGP when the measurement gap is not used for measurements.

In a further particular embodiment, the message comprises a parameter for determining whether the transition from the first MGP to the second MGP is triggered, the parameter comprising at least one of: a configuration for measurements in a radio access technology, a configuration or deconfiguration of a number of carrier frequencies for performance of measurements by the wireless device, a configuration for measurements on at least one reference signal, a configuration for measurements on a type of reference signal, a measurement or measurement type, a procedure, a characteristic of a signal or a measurement, an activity or inactivity level, a characteristic associated with a traffic level, and a timing parameter.

In various particular embodiments, the method may include one or more of any of the steps or features of the Group B and Group E Example Embodiments described below.

FIG. 17 illustrates a schematic block diagram of a virtual apparatus 1300 in a wireless network (for example, the wireless network shown in FIG. 3). The apparatus may be implemented in a wireless device or network node (e.g., wireless device 110 or network node 160 shown in FIG. 3). Apparatus 1300 is operable to carry out the example method described with reference to FIG. 16 and possibly any other processes or methods disclosed herein. It is also to be understood that the method of FIG. 16 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1310 and any other suitable units of apparatus 1300 to perform corresponding functions according one or more embodiments of the present disclosure.

According to certain embodiments, transmitting module 1310 may perform certain of the transmitting functions of the apparatus 1300. For example, transmitting module 1310 may transmit a message to a wireless device to trigger the wireless device to maintain a first set of properties associated with a first MGP and adapting a second set of properties associated with a first MGP while transitioning from the first MGP to a second MGP.

Optionally, in particular embodiments, virtual apparatus may additionally include one or more modules for performing any of the steps or providing any of the features in the Group B and Group E Example Embodiments described below.

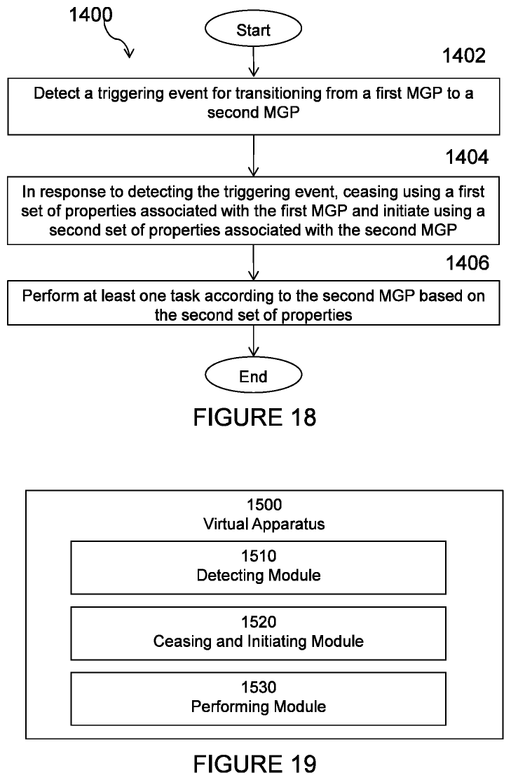

FIG. 18 depicts a method 1400 by a wireless device 110 for transitioning between MGPs, according to certain embodiments. At step 1402, the wireless device 110 detects a triggering event for transitioning from a first MGP to a second MGP. In response to detecting the triggering event, the wireless device 110 ceases using a first set of properties associated with the first MGP and initiates using of a second set of properties associated with the second MGP, at step 1404. At step 1406, the wireless device 110 performs at least one task according to the second MGP based on the second set of properties.

In a particular embodiment, the first MGP comprises a PMGP and the second MGP comprises a NMGP or the first MGP comprises a NMGP and the second MGP comprises a PMGP.

In a particular embodiment, at least one of the first set of properties and the second set of properties comprises a property or parameter associated with scheduling during measurement gaps.

In a particular embodiment, at least one of the first set of properties and the second set of properties comprises any one or more of: a property associated with a measurement gap length, MGL, a property associated with a measurement gap repetition period, MGRP, and a property associated with an offset.

In a particular embodiment, performing the at least one task comprises at least one of: performing at least one measurement during a measurement gap according to the second MGP, and receiving scheduling during a measurement gap of the second MGP when the measurement gap is not used for measurements.

In a particular embodiment, detecting the triggering event for transitioning from the first MGP to the second MGP comprises receiving at least one message from a network node.

In a particular embodiment, the message comprises at least one of: a configuration of a signal, a measurement or measurement type, a procedure, a characteristic of a signal or a measurement, an activity or inactivity level, a characteristic associated with a traffic level, and a timing parameter.

In a particular embodiment, detecting the triggering event for transitioning from the first MGP to the second MGP comprises at least one of: detecting a configuration for measurements in a radio access technology; detecting a configuration or deconfiguration of a number of carrier frequencies for performance of measurements; detecting a configuration for measurements on at least one reference signal; and detecting a configuration for measurements on a type of reference signal.

In various particular embodiments, the method may additionally or alternatively include one or more of the steps or features of the Group C and Group E Example Embodiments described below.

FIG. 19 illustrates a schematic block diagram of a virtual apparatus 1500 in a wireless network (for example, the wireless network shown in FIG. 3). The apparatus may be implemented in a wireless device or network node (e.g., wireless device 110 or network node 160 shown in FIG. 3). Apparatus 1500 is operable to carry out the example method described with reference to FIG. 18 and possibly any other processes or methods disclosed herein. It is also to be understood that the method of FIG. 18 is not necessarily carried out solely by apparatus 1500. At least some operations of the method can be performed by one or more other entities.

Virtual Apparatus 1500 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause detecting module 1510, ceasing and initiating module 1520, performing module 1530 and any other suitable units of apparatus 1500 to perform corresponding functions according one or more embodiments of the present disclosure.

According to certain embodiments, detecting module 1510 may perform certain of the detecting functions of the apparatus 1500. For example, detecting module 1510 may detect a triggering event for transitioning from a first MGP to a second MGP.

According to certain embodiments, ceasing and initiating module 1520 may perform certain of the ceasing and initiating functions of the apparatus 1500. For example, in response to detecting the triggering event, ceasing and initiating module 1520 may cease using a first set of properties associated with the first MGP and initiate using of a second set of properties associated with the second MGP.

According to certain embodiments, performing module 1530 may perform certain of the performing functions of the apparatus 1500. For example, performing module 1520 may perform at least one task according to the second MGP based on the second set of properties.

Optionally, in particular embodiments, virtual apparatus may additionally include one or more modules for performing any of the steps or providing any of the features in the Group C and Group E Example Embodiments described below.

As used herein, the term module or unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

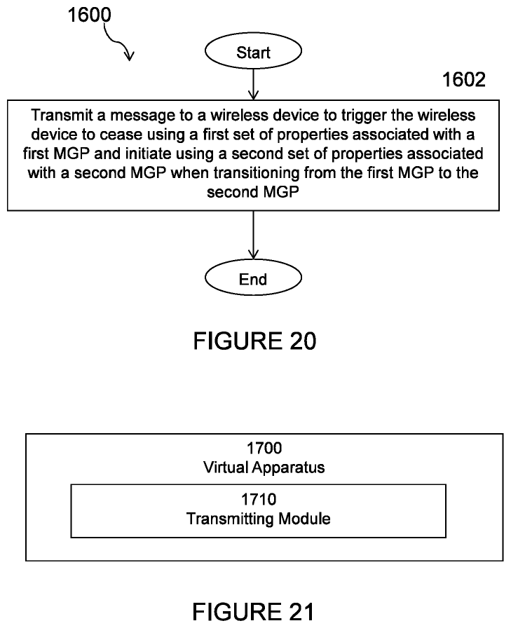

FIG. 20 depicts a method 1600 by a network node 160 for assisting a wireless device 110 in transitioning between MGPs, according to certain embodiments. At step 1602, the network node 160 transmits a message to the wireless device 110 to trigger the wireless device 110 to cease using a first set of properties associated with a first MGP and initiate using of a second set of properties associated with a second MGP when transitioning from the first MGP to the second MGP.

In a particular embodiment, the first MGP comprises a PMGP and the second MGP comprises a NMGP, or the first MGP comprises a NMGP and the second MGP comprises a PMGP.

In a particular embodiment, at least one of the first set of properties and the second set of properties comprises a property or parameter associated with scheduling during measurement gaps.

In a particular embodiment, at least one of the first set of properties and the second set of properties comprises any one or more of: a property associated with a measurement gap length, MGL, a property associated with a measurement gap repetition period, MGRP, and a property associated with an offset.

In a particular embodiment, the network node 160 transmits scheduling to the wireless device during a measurement gap of the second MGP when the measurement gap is not used for measurements.

In a particular embodiment, the message comprises at least one parameter, the at least one parameter comprising at least one of: a configuration of a signal, a measurement or measurement type, a procedure, a characteristic of a signal or a measurement, an activity or inactivity level, a characteristic associated with a traffic level, and a timing parameter.

In a particular embodiment, the message comprises at least one of: a configuration for measurements in a radio access technology, a configuration or deconfiguration of a number of carrier frequencies for performance of measurements; a configuration for measurements on at least one reference signal, and a configuration for measurements on a type of reference signal.

In various particular embodiments, the method may include one or more of any of the steps or features of the Group D and Group E Example Embodiments described below.

FIG. 21 illustrates a schematic block diagram of a virtual apparatus 1700 in a wireless network (for example, the wireless network shown in FIG. 3). The apparatus may be implemented in a wireless device or network node (e.g., wireless device 110 or network node 160 shown in FIG. 3). Apparatus 1700 is operable to carry out the example method described with reference to FIG. 20 and possibly any other processes or methods disclosed herein. It is also to be understood that the method of FIG. 20 is not necessarily carried out solely by apparatus 1700. At least some operations of the method can be performed by one or more other entities.

Virtual Apparatus 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause transmitting module 1710 and any other suitable units of apparatus 1700 to perform corresponding functions according one or more embodiments of the present disclosure.

According to certain embodiments, transmitting module 1710 may perform certain of the transmitting functions of the apparatus 1700. For example, transmitting module 1710 may transmit a message to the wireless device to trigger the wireless device to cease using a first set of properties associated with a first MGP and initiate using of a second set of properties associated with a second MGP when transitioning from the first MGP to the second MGP.

Optionally, in particular embodiments, virtual apparatus may additionally include one or more modules for performing any of the steps or providing any of the features in the Group D and Group E Example Embodiments described below.

### EXAMPLE EMBODIMENTS

### Group A Example Embodiments

Example Embodiment A1. A method by a wireless device for transitioning between measurement gap patterns (MGPs), the method comprising: detecting a triggering event for transitioning from a first MGP to a second MGP; in response to detecting the triggering event, maintaining a first set of properties associated with the first MGP and adapting a second set of properties associated with the first MGP; performing at least one task according to the second MGP based on the first set of properties and the second set of properties.

Example Embodiment A2. The method of Example Embodiment A1, wherein: the first MGP comprises a Predefined MGP (PMGP) and the second MGP comprises a normal MGP (NMGP).

Example Embodiment A3. The method of Example Embodiment A1, wherein: the first MGP comprises a Normal MGP (NMGP) and the second MGP comprises a Predefined MGP (PMGP).

Example Embodiment A4. The method of any one of Example Embodiments A1 to A3, wherein the second set of properties comprises a property/parameter associated with scheduling during measurement gaps.

Example Embodiment A5. The method of Example Embodiment A4, wherein a frequency or bandwidth of a reference signal is within a frequency or bandwidth of an active bandwidth part (BWP) of the wireless device.

Example Embodiment A6. The method of any one of Example Embodiments A1 to A5, wherein the first set of properties comprises any one or more of: a property associated with a measurement gap length (MGL), a property associated with a measurement gap repetition period (MGRP), and a property associated with an offset.

Example Embodiment A7. The method of any one of Example Embodiments A1 to A5, wherein maintaining the first set of properties associated with the first MGP comprises reusing the first set of properties while performing the at least one task according to the second MGP.

Example Embodiment A8. The method of any one of Example Embodiments A1 to A7, wherein performing the at least one task comprises performing at least one measurement during a measurement gap according to the second MGP.

Example Embodiment A9. The method of any one of Embodiments A1 to A8, wherein performing the at least one task comprises receiving scheduling during a measurement gap of the second MGP when the measurement gap is not used for measurements.

Example Embodiment A10. The method of any one of Example Embodiments A1 to A9, wherein detecting the triggering event for transitioning from the first MGP to the second MGP comprises receiving at least one message and/or at least one indication and/or at least one parameter from a network node.

Example Embodiment A11. The method of Example Embodiment A10, wherein the at least one message and/or the at least one indication and/or the at least one parameter is received via downlink control information (DCI), radio resource control (RRC) message, or Medium Access Control (MAC) command.

Example Embodiment A12. The method of any one of Example Embodiments A10 to A11, wherein the at least one message and/or the at least one indication and/or the at least one parameter is received via a dedicated message, a broadcast message, a multicast message, or system information.

Example Embodiment A13. The method of Example Embodiment A12, wherein the at least one parameter comprises a threshold for determining whether the transition is triggered.

Example Embodiment A14. The method of Example Embodiment A12, wherein the at least one parameter comprises at least one of: a configuration of a signal, a measurement or measurement type, a procedure, a characteristic of a signal or a measurement, an activity or inactivity level, a characteristic associated with a traffic level, and a timing parameter.

Example Embodiment A15. The method of any one of Example Embodiments A1 to A14, wherein detecting the triggering event for transitioning from the first MGP to the second MGP comprises detecting the expiration of a timer.

Example Embodiment A16. The method of any one of Example Embodiments A1 to A14, wherein detecting the triggering event for transitioning from the first MGP to the second MGP comprises detecting an initiation of a timer.

Example Embodiment A17. The method of any one of Example Embodiments A1 to A16, wherein performing the at least one task comprises starting a timer.

Example Embodiment A18. The method of any one of Example Embodiments A1 to A17, wherein detecting the triggering event for transitioning from the first MGP to the second MGP comprises receiving a configuration or deconfiguration associated with a particular number of carrier frequencies.

Example Embodiment A19. The method of any one of Example Embodiments A1 to A18, wherein detecting the triggering event for transitioning from the first MGP to the second MGP comprises detecting a configuration for measurements on a carrier frequency within a particular frequency range (FR).

Example Embodiment A20. The method of any one of Example Embodiments A1 to A19, wherein detecting the triggering event for transitioning from the first MGP to the second MGP comprises detecting a configuration for measurements in a particular radio access technology.

Example Embodiment A21. The method of any one of Example Embodiments A1 to A20, wherein detecting the triggering event for transitioning from the first MGP to the second MGP comprises detecting a configuration for measurements on at least one reference signal associated with a frequency and/or bandwidth that is outside a bandwidth or frequency of an active BWP of the wireless device.

Example Embodiment A22. The method of any one of Example Embodiments A1 to A21, wherein detecting the triggering event for transitioning from the first MGP to the second MGP comprises detecting a configuration for measurements on a particular type of reference signal.

Example Embodiment A23. The method of any one of Example Embodiments A1 to A22, wherein detecting the triggering event for transitioning from the first MGP to the second MGP comprises detecting a fulfillment of a condition associated with a periodicity, activity level of the wireless device, and a similarity between the first MGP and the second MGP.

Example Embodiment A24. The method of any one of Example Embodiments A1 to A23, further comprising determining when to transition from the first MGP to the second MGP.

Example Embodiment A25. The method of any one of Example Embodiments A1 to A24, further comprising determining how long to operate according to the second MGP.

Example Embodiment A26. The method of any one of Example Embodiments A1 to A25, wherein the wireless device comprises a user equipment (UE).

Example Embodiment A27. A wireless device comprising processing circuitry configured to perform any of the methods of Example Embodiments A1 to A26.

Example Embodiment A28. A computer program comprising instructions which when executed on a computer perform any of the methods of Example Embodiments A1 to A26.

Example Embodiment A29. A computer program product comprising computer program, the computer program comprising instructions which when executed on a computer perform any of the methods of Example Embodiments A1 to A27.

Example Embodiment A30. A non-transitory computer readable medium storing instructions which when executed by a computer perform any of the methods of Example Embodiments A1 to A27.

### Group B Embodiments

Example Embodiment B1. A method by a network node for assisting a wireless device in transitioning between measurement gap patterns (MGPs), the method comprising: transmitting a message to a wireless device to trigger the wireless device to maintain a first set of properties associated with a first MGP and adapting a second set of properties associated with a first MGP while transitioning from the first MGP to a second MGP.

Example Embodiment B2. The method of Example Embodiment B1, wherein: the first MGP comprises a Predefined MGP (PMGP) and the second MGP comprises a normal MGP (NMGP).

Example Embodiment B3. The method of Example Embodiment B1, wherein: the first MGP comprises a Normal MGP (NMGP) and the second MGP comprises a Predefined MGP (PMGP).

Example Embodiment B4. The method of any one of Example Embodiments B1 to B3, wherein the second set of properties comprises a property/parameter associated with scheduling during measurement gaps.

Example Embodiment B5. The method of Example Embodiment B4, wherein a frequency or bandwidth of a reference signal is within a frequency or bandwidth of an active bandwidth part (BWP) of the wireless device.

Example Embodiment B6. The method of any one of Example Embodiments B1 to B5, wherein the first set of properties comprises any one or more of: a property associated with a measurement gap length (MGL), a property associated with a measurement gap repetition period (MGRP), and a property associated with an offset.

Example Embodiment B7. The method of any one of Example Embodiments B1 to B6, wherein maintaining the first set of properties associated with the first MGP comprises reusing the first set of properties while performing the at least one task according to the second MGP.

Example Embodiment B8. The method of any one of Example Embodiments B1 to B7, further comprising configuring the wireless device to perform at least one measurement during a measurement gap according to the second MGP.

Example Embodiment B9. The method of any one of Embodiments B1 to B8, further comprising transmitting scheduling during a measurement gap of the second MGP when the measurement gap is not used for measurements.

Example Embodiment B10. The method of any one of Example Embodiments B1 to B9, wherein the message is transmitted to the wireless device via downlink control information (DCI), radio resource control (RRC) message, or Medium Access Control (MAC) command.

Example Embodiment B11. The method of any one of Example Embodiments B1 to B10, wherein the message is transmitted via a dedicated message, a broadcast message, a multicast message, or system information.

Example Embodiment B12. The method of any one of Example Embodiments B1 to B11, wherein the message comprises a threshold for determining whether the transition from the first MGP to the second MGP is triggered.

Example Embodiment B13. The method of any one of Example Embodiments B1 to B12, wherein the message comprises a parameter for determining whether the transition from the first MGP to the second MGP is triggered, the parameter comprising at least one of: a configuration of a signal, a measurement or measurement type, a procedure, a characteristic of a signal or a measurement, an activity or inactivity level, a characteristic associated with a traffic level, and a timing parameter.

Example Embodiment B14. The method of any one of Example Embodiments B1 to B13, further comprising configuring the wireless device to transition from the first MGP to the second MGP upon an expiration of a timer.

Example Embodiment B15. The method of any one of Example Embodiments B1 to B14, further comprising configuring the wireless device to start a timer upon transitioning from the first MGP to the second MGP.

Example Embodiment B16. The method of any one of Example Embodiments B1 to B15, wherein the message comprises a configuration or deconfiguration associated with a particular number of carrier frequencies.

Example Embodiment B17. The method of any one of Example Embodiments B1 to B16, wherein the message comprises a configuration for measurements on a carrier frequency within a particular frequency range (FR).

Example Embodiment B18. The method of any one of Example Embodiments B1 to B17, wherein the message comprises a configuration for measurements in a particular radio access technology.

Example Embodiment B19. The method of any one of Example Embodiments B1 to B20, wherein the message comprises a configuration for measurements on at least one reference signal associated with a frequency and/or bandwidth that is outside a bandwidth or frequency of an active BWP of the wireless device.

Example Embodiment B20. The method of any one of Example Embodiments B1 to B19, wherein the message comprises a configuration for measurements on a particular type of reference signal.

Example Embodiment B21. The method of any one of Example Embodiments B1 to B20, wherein the message indicates when the wireless device is to transition from the first MGP to the second MGP.

Example Embodiment B22. The method of any one of Example Embodiments B1 to B21, wherein the message indicates how long the wireless device is to operate according to the second MGP.

Example Embodiment B23. The method of any one of Example Embodiments B1 to B22, wherein the network node comprises a gNodeB (gNB).

Example Embodiment B24. A network node comprising processing circuitry configured to perform any of the methods of Example Embodiments B1 to B23.

Example Embodiment B25. A computer program comprising instructions which when executed on a computer perform any of the methods of Example Embodiments B1 to B23.

Example Embodiment B26. A computer program product comprising computer program, the computer program comprising instructions which when executed on a computer perform any of the methods of Example Embodiments B1 to B23.

Example Embodiment B27. A non-transitory computer readable medium storing instructions which when executed by a computer perform any of the methods of Example Embodiments B1 to B23.

### Group C Example Embodiments

Example Embodiment C1. A method by a wireless device for transitioning between measurement gap patterns (MGPs), the method comprising: detecting a triggering event for transitioning from a first MGP to a second MGP; in response to detecting the triggering event, ceasing to use a first set of properties associated with the first MGP and initiating use of a second set of properties associated with the second MGP; and performing at least one task according to the second MGP based on the second set of properties.

Example Embodiment C2. The method of Example Embodiment C1, wherein: the first MGP comprises a Predefined MGP (PMGP) and the second MGP comprises a normal MGP (NMGP).

Example Embodiment C3. The method of Example Embodiment C1, wherein: the first MGP comprises a Normal MGP (NMGP) and the second MGP comprises a Predefined MGP (PMGP).

Example Embodiment C4. The method of any one of Example Embodiments C1 to C3, wherein the first set of properties and/or the second set of properties comprises a property/parameter associated with scheduling during measurement gaps.

Example Embodiment C5. The method of Example Embodiment C4, wherein a frequency or bandwidth of a reference signal is within a frequency or bandwidth of an active bandwidth part (BWP) of the wireless device.

Example Embodiment C6. The method of any one of Example Embodiments C1 to C5, wherein at least one of the first set of properties and the second set of properties comprises any one or more of: a property associated with a measurement gap length (MGL), a property associated with a measurement gap repetition period (MGRP), and a property associated with an offset.

Example Embodiment C7. The method of any one of Example Embodiments C1 to C6, wherein performing the at least one task comprises performing at least one measurement during a measurement gap according to the second MGP.

Example Embodiment C8. The method of any one of Embodiments C1 to C7, wherein performing the at least one task comprises receiving scheduling during a measurement gap of the second MGP when the measurement gap is not used for measurements.

Example Embodiment C9. The method of any one of Example Embodiments C1 to C8, wherein detecting the triggering event for transitioning from the first MGP to the second MGP comprises receiving at least one message and/or at least one indication and/or at least one parameter from a network node.

Example Embodiment C10. The method of Example Embodiment C9, wherein the at least one message and/or the at least one indication and/or the at least one parameter is received via downlink control information (DCI), radio resource control (RRC) message, or Medium Access Control (MAC) command.

Example Embodiment C11. The method of any one of Example Embodiments C9 to C10, wherein the at least one message and/or the at least one indication and/or the at least one parameter is received via a dedicated message, a broadcast message, a multicast message, or system information.

Example Embodiment C12. The method of Example Embodiment C11, wherein the at least one parameter comprises a threshold for determining whether the transition is triggered.

Example Embodiment C13. The method of Example Embodiment C11, wherein the at least one parameter comprises at least one of: a configuration of a signal, a measurement or measurement type, a procedure, a characteristic of a signal or a measurement, an activity or inactivity level, a characteristic associated with a traffic level, and a timing parameter.

Example Embodiment C14. The method of any one of Example Embodiments C1 to C13, wherein detecting the triggering event for transitioning from the first MGP to the second MGP comprises detecting the expiration of a timer.

Example Embodiment C15. The method of any one of Example Embodiments C1 to C14, wherein detecting the triggering event for transitioning from the first MGP to the second MGP comprises detecting an initiation of a timer.

Example Embodiment C16. The method of any one of Example Embodiments C1 to C15, wherein performing the at least one task comprises starting a timer.

Example Embodiment C17. The method of any one of Example Embodiments C1 to C16, wherein detecting the triggering event for transitioning from the first MGP to the second MGP comprises receiving a configuration or deconfiguration associated with a particular number of carrier frequencies.

Example Embodiment C18. The method of any one of Example Embodiments C1 to C17, wherein detecting the triggering event for transitioning from the first MGP to the second MGP comprises detecting a configuration for measurements on a carrier frequency within a particular frequency range (FR).

Example Embodiment C19. The method of any one of Example Embodiments C1 to C18, wherein detecting the triggering event for transitioning from the first MGP to the second MGP comprises detecting a configuration for measurements in a particular radio access technology.

Example Embodiment C20. The method of any one of Example Embodiments C1 to C19, wherein detecting the triggering event for transitioning from the first MGP to the second MGP comprises detecting a configuration for measurements on at least one reference signal associated with a frequency and/or bandwidth that is outside a bandwidth or frequency of an active BWP of the wireless device.

Example Embodiment C21. The method of any one of Example Embodiments C1 to C20, wherein detecting the triggering event for transitioning from the first MGP to the second MGP comprises detecting a configuration for measurements on a particular type of reference signal.

Example Embodiment C22. The method of any one of Example Embodiments C1 to C21, wherein detecting the triggering event for transitioning from the first MGP to the second MGP comprises detecting a fulfillment of a condition associated with a periodicity, activity level of the wireless device, and a similarity between the first MGP and the second MGP.

Example Embodiment C23. The method of any one of Example Embodiments C1 to C22, further comprising determining when to transition from the first MGP to the second MGP.

Example Embodiment C24. The method of any one of Example Embodiments C1 to C23, further comprising determining how long to operate according to the second MGP.

Example Embodiment C25. The method of any one of Example Embodiments C1 to C24, wherein detecting the triggering event for transitioning from the first MGP to the second MGP comprises receiving a message from a network node, the message indicating the second MGP.

Example Embodiment C26. The method of any one of Example Embodiments C1 to C25, wherein the wireless device comprises a user equipment (UE). Example Embodiment C27. A wireless device comprising processing circuitry configured to perform any of the methods of Example Embodiments C1 to C26.

Example Embodiment C28. A computer program comprising instructions which when executed on a computer perform any of the methods of Example Embodiments C1 to C26.

Embodiment A computer program product comprising computer program, the computer program comprising instructions which when executed on a computer perform any of the methods of Example Embodiments C1 to C26.

Example Embodiment C30. A non-transitory computer readable medium storing instructions which when executed by a computer perform any of the methods of Example Embodiments C1 to C26.

### Group D Example Embodiments

Example Embodiment D1. A method by a network node for assisting a wireless device in transitioning between measurement gap patterns (MGPs), the method comprising: transmitting a message to the wireless device to trigger the wireless device to cease using a first set of properties associated with a first MGP and initiate using of a second set of properties associated with a second MGP when transitioning from the first MGP to the second MGP.

Example Embodiment D2. The method of Example Embodiment D1, wherein: the first MGP comprises a Predefined MGP (PMGP) and the second MGP comprises a normal MGP (NMGP).

Example Embodiment D3. The method of Example Embodiment D1, wherein: the first MGP comprises a Normal MGP (NMGP) and the second MGP comprises a Predefined MGP (PMGP).

Example Embodiment D4. The method of any one of Example Embodiments D1 to D3, wherein the first set of properties and/or the second set of properties comprises a property/parameter associated with scheduling during measurement gaps.

Example Embodiment D5. The method of Example Embodiment D4, wherein a frequency or bandwidth of a reference signal is within a frequency or bandwidth of an active bandwidth part (BWP) of the wireless device.

Example Embodiment D6. The method of any one of Example Embodiments D1 to D5, wherein at least one of the first set of properties and the second set of properties comprises any one or more of: a property associated with a measurement gap length (MGL), a property associated with a measurement gap repetition period (MGRP), and a property associated with an offset.

Example Embodiment D7. The method of any one of Embodiments D1 to D6, further comprising transmitting scheduling to the wireless device during a measurement gap of the second MGP when the measurement gap is not used for measurements.

Example Embodiment D8. The method of any one of Example Embodiments D1 to D7, wherein the message is transmitted via downlink control information (DCI), radio resource control (RRC) message, or Medium Access Control (MAC) command.

Example Embodiment D9. The method of any one of Example Embodiments D1 to D8, wherein the message is transmitted via a dedicated message, a broadcast message, a multicast message, or system information.

Example Embodiment D10. The method of any one of Example Embodiments D1 to D9, wherein the message comprises a threshold for determining whether to transition from the first MGP to the second MGP.

Example Embodiment D11. The method of any one of Example Embodiments D1 to D10, wherein the message comprises at least one parameter, the at least one parameter comprising at least one of: a configuration of a signal, a measurement or measurement type, a procedure, a characteristic of a signal or a measurement, an activity or inactivity level, a characteristic associated with a traffic level, and a timing parameter.

Example Embodiment D12. The method of any one of Example Embodiments D1 to D11, further comprising configuring the wireless device to transition from the first MGP to the second MGP upon detecting an expiration of a timer.

Example Embodiment D13. The method of any one of Example Embodiments D1 to D12, further comprising configuring the wireless device to start a timer when transitioning to the second MGP.

Example Embodiment D14. The method of any one of Example Embodiments D1 to D13, wherein the message comprises a configuration or deconfiguration associated with a particular number of carrier frequencies.

Example Embodiment D15. The method of any one of Example Embodiments D1 to D14, wherein the message comprises a configuration for measurements on a carrier frequency within a particular frequency range (FR).

Example Embodiment D16. The method of any one of Example Embodiments D1 to D15, wherein the message comprises a configuration for measurements in a particular radio access technology.

Example Embodiment D17. The method of any one of Example Embodiments D1 to D16, wherein the message comprises a configuration for measurements on at least one reference signal associated with a frequency and/or bandwidth that is outside a bandwidth or frequency of an active BWP of the wireless device.

Example Embodiment D18. The method of any one of Example Embodiments D1 to D17, wherein the message comprises a configuration for measurements on a particular type of reference signal.

Example Embodiment D19. The method of any one of Example Embodiments D1 to D18, further comprising configuring the wireless device to transition from the first MGP to the second MGP upon detecting a fulfillment of a condition associated with a periodicity, activity level of the wireless device, and a similarity between the first MGP and the second MGP.

Example Embodiment D20. The method of any one of Example Embodiments D1 to D19, wherein the message indicates when the wireless device is to transition from the first MGP to the second MGP.

Example Embodiment D21. The method of any one of Example Embodiments D1 to D20, wherein the message indicates how long the wireless device is to operate according to the second MGP.

Example Embodiment D22. The method of any one of Example Embodiments D1 to D21, wherein the message indicates the second MGP.

Example Embodiment D23. The method of any one of Example Embodiments D1 to D22, wherein the wireless device comprises a user equipment (UE).

Example Embodiment D24. The method of any one of Example Embodiments D1 to D23, wherein the network node comprises a gNodeB (gNB). Example Embodiment D25. A network node comprising processing circuitry configured to perform any of the methods of Example Embodiments D1 to D24.

Example Embodiment D26. A computer program comprising instructions which when executed on a computer perform any of the methods of Example Embodiments D1 to D24.

Example Embodiment D27. A computer program product comprising computer program, the computer program comprising instructions which when executed on a computer perform any of the methods of Example Embodiments D1 to D24.

Example Embodiment D28. A non-transitory computer readable medium storing instructions which when executed by a computer perform any of the methods of Example Embodiments D1 to D24.

### Group E Example Embodiments

Example Embodiment E1. A wireless device comprising: processing circuitry configured to perform any of the steps of any of the Group A and Group C Example Embodiments; and power supply circuitry configured to supply power to the wireless device.

Example Embodiment E2. A network node comprising: processing circuitry configured to perform any of the steps of any of the Group B and Group D Example Embodiments; power supply circuitry configured to supply power to the wireless device.

Example Embodiment E3. A wireless device, the wireless device comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and Group C Example Embodiments; an input interface connected to the processing circuitry and configured to allow input of information into the wireless device to be processed by the processing circuitry; an output interface connected to the processing circuitry and configured to output information from the wireless device that has been processed by the processing circuitry; and a battery connected to the processing circuitry and configured to supply power to the wireless device.

Example Embodiment E4. A communication system including a host computer comprising: processing circuitry configured to provide user data; and a communication interface configured to forward the user data to a cellular network for transmission to a wireless device, wherein the cellular network comprises a network node having a radio interface and processing circuitry, the network node's processing circuitry configured to perform any of the steps of any of the Group B and Group D Example Embodiments.

Example Embodiment E5. The communication system of the pervious embodiment further including the network node.

Example Embodiment E6. The communication system of the previous 2 embodiments, further including the wireless device, wherein the wireless device is configured to communicate with the network node.

Example Embodiment E7. The communication system of the previous 3 embodiments, wherein: the processing circuitry of the host computer is configured to execute a host application, thereby providing the user data; and the wireless device comprises processing circuitry configured to execute a client application associated with the host application.

Example Embodiment E8. A method implemented in a communication system including a host computer, a network node and a wireless device, the method comprising: at the host computer, providing user data; and at the host computer, initiating a transmission carrying the user data to the wireless device via a cellular network comprising the network node, wherein the network node performs any of the steps of any of the Group B and Group D Example Embodiments.

Example Embodiment E9. The method of the previous embodiment, further comprising, at the network node, transmitting the user data.

Example Embodiment E10. The method of the previous 2 embodiments, wherein the user data is provided at the host computer by executing a host application, the method further comprising, at the wireless device, executing a client application associated with the host application.

Example Embodiment E11. A wireless device configured to communicate with a network node, the wireless device comprising a radio interface and processing circuitry configured to performs the of the previous 3 embodiments.

Example Embodiment E12. A communication system including a host computer comprising: processing circuitry configured to provide user data; and a communication interface configured to forward user data to a cellular network for transmission to a wireless device, wherein the wireless device comprises a radio interface and processing circuitry, the wireless device's components configured to perform any of the steps of any of the Group A and Group C Example Embodiments.

Example Embodiment E13. The communication system of the previous embodiment, wherein the cellular network further includes a network node configured to communicate with the wireless device.

Example Embodiment E14. The communication system of the previous 2 embodiments, wherein: the processing circuitry of the host computer is configured to execute a host application, thereby providing the user data; and the wireless device's processing circuitry is configured to execute a client application associated with the host application.

Example Embodiment E15. A method implemented in a communication system including a host computer, a network node and a wireless device, the method comprising: at the host computer, providing user data; and at the host computer, initiating a transmission carrying the user data to the wireless device via a cellular network comprising the network node, wherein the wireless device performs any of the steps of any of the Group A and Group C Example Embodiments.

Example Embodiment E16. The method of the previous embodiment, further comprising at the wireless device, receiving the user data from the network node.

Example Embodiment E17. A communication system including a host computer comprising: communication interface configured to receive user data originating from a transmission from a wireless device to a network node, wherein the wireless device comprises a radio interface and processing circuitry, the wireless device's processing circuitry configured to perform any of the steps of any of the Group A and Group C Example Embodiments.

Example Embodiment E18. The communication system of the previous embodiment, further including the wireless device.

Example Embodiment E19. The communication system of the previous 2 embodiments, further including the network node, wherein the network node comprises a radio interface configured to communicate with the wireless device and a communication interface configured to forward to the host computer the user data carried by a transmission from the wireless device to the network node.

Example Embodiment E20. The communication system of the previous 3 embodiments, wherein: the processing circuitry of the host computer is configured to execute a host application; and the wireless device's processing circuitry is configured to execute a client application associated with the host application, thereby providing the user data.

Example Embodiment E21. The communication system of the previous 4 embodiments, wherein: the processing circuitry of the host computer is configured to execute a host application, thereby providing request data; and the wireless device's processing circuitry is configured to execute a client application associated with the host application, thereby providing the user data in response to the request data.

Example Embodiment E22. A method implemented in a communication system including a host computer, a network node and a wireless device, the method comprising: at the host computer, receiving user data transmitted to the network node from the wireless device, wherein the wireless device performs any of the steps of any of the Group A and Group C Example Embodiments.

Example Embodiment E23. The method of the previous embodiment, further comprising, at the wireless device, providing the user data to the network node.

Example Embodiment E24. The method of the previous 2 embodiments, further comprising: at the wireless device, executing a client application, thereby providing the user data to be transmitted; and at the host computer, executing a host application associated with the client application.

Example Embodiment E25. The method of the previous 3 embodiments, further comprising: at the wireless device, executing a client application; and at the wireless device, receiving input data to the client application, the input data being provided at the host computer by executing a host application associated with the client application, wherein the user data to be transmitted is provided by the client application in response to the input data.

Example Embodiment E26. A communication system including a host computer comprising a communication interface configured to receive user data originating from a transmission from a wireless device to a network node, wherein the network node comprises a radio interface and processing circuitry, the network node's processing circuitry configured to perform any of the steps of any of the Group B and Group D Example Embodiments.

Example Embodiment E27. The communication system of the previous embodiment further including the network node.

Example Embodiment E28. The communication system of the previous 2 embodiments, further including the wireless device, wherein the wireless device is configured to communicate with the network node.

Example Embodiment E29. The communication system of the previous 3 embodiments, wherein: the processing circuitry of the host computer is configured to execute a host application; the wireless device is configured to execute a client application associated with the host application, thereby providing the user data to be received by the host computer.

Example Embodiment E30. A method implemented in a communication system including a host computer, a network node and a wireless device, the method comprising: at the host computer, receiving, from the base station, user data originating from a transmission which the network node has received from the wireless device, wherein the wireless device performs any of the steps of any of the Group A and Group C Example Embodiments.

Example Embodiment E31. The method of the previous embodiment, further comprising at the network node receiving the user data from the wireless device.

Example Embodiment E32. The method of the previous 2 embodiments, further comprising at the network node, initiating a transmission of the received user data to the host computer.

Example Embodiment E33. The method of any of the previous embodiments, wherein the network node comprises a base station.

Example Embodiment E34. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1.-31. (canceled)

32. A wireless device for transitioning between measurement gap patterns, MGPs, the wireless device adapted to:
detect a triggering event for transitioning from a first MGP to a second MGP;
in response to detecting the triggering event, maintain a first set of properties associated with the first MGP and adapt a second set of properties associated with the first MGP;
perform at least one task according to the second MGP based on the first set of properties and the second set of properties.

33. The wireless device of claim 32, wherein:
the first MGP comprises a Predefined MGP, PMGP, and the second MGP comprises a normal MGP, NMGP, or
the first MGP comprises a NMGP and the second MGP comprises a PMGP.

34. The wireless device of claim 32, wherein the second set of properties comprises a property or parameter associated with scheduling during measurement gaps.

35. The wireless device of claim 32, wherein the first set of properties comprises any one or more of:
a property associated with a measurement gap length, MGL,
a property associated with a measurement gap repetition period, MGRP, and
a property associated with an offset.

36. The wireless device of claim 32, wherein when maintaining the first set of properties associated with the first MGP the wireless device is adapted to reuse the first set of properties while performing the at least one task according to the second MGP.

37. The wireless device of claim 32, wherein when performing the at least one task the wireless device is adapted to perform at least one of:
perform at least one measurement during a measurement gap according to the second MGP, and
receive scheduling during a measurement gap of the second MGP when the measurement gap is not used for measurements.

38. The wireless device of claim 32, wherein when detecting the triggering event for transitioning from the first MGP to the second MGP the wireless device is adapted to receive at least one message from a network node.

39. The wireless device of claim 38, wherein the at least one message comprises at least one of:
a configuration of a signal,
a measurement or measurement type,
a procedure,
a characteristic of a signal or a measurement,
an activity or inactivity level,
a characteristic associated with a traffic level, and
a timing parameter.

40. The wireless device of claim 32, wherein when detecting the triggering event for transitioning from the first MGP to the second MGP the wireless device is adapted to perform at least one of:
detect a configuration for measurements in a radio access technology;
detect a configuration or deconfiguration of a number of carrier frequencies for performance of measurements;
detect a configuration for measurements on at least one reference signal; and
detect a configuration for measurements on a type of reference signal.

41. A network node for assisting a wireless device in transitioning between measurement gap patterns, MGPs, the network node adapted to:
transmit a message to a wireless device to trigger the wireless device to maintain a first set of properties associated with a first MGP and adapting a second set of properties associated with a first MGP while transitioning from the first MGP to a second MGP.

42. The network node of claim 41, wherein:
the first MGP comprises a Predefined MGP, PMGP, and the second MGP comprises a normal MGP, NMGP, or
the first MGP comprises a NMGP and the second MGP comprises a PMGP.

43. The network node of claim 41, wherein the second set of properties comprises a property or parameter associated with scheduling during measurement gaps.

44. The network node of claim 41, wherein the first set of properties comprises any one or more of:
a property associated with a measurement gap length, MGL,
a property associated with a measurement gap repetition period, MGRP, and
a property associated with an offset.

45. The network node of claim 41, wherein the message indicates or triggers the wireless device to reuse the first set of properties while performing the at least one task according to the second MGP.

46. The network node of claim 41, further adapted to transmit scheduling during a measurement gap of the second MGP when the measurement gap is not used for measurements.

47. The network node of claim 41, wherein the message comprises a parameter for determining whether the transition from the first MGP to the second MGP is triggered, the parameter comprising at least one of:
a configuration for measurements in a radio access technology,
a configuration or deconfiguration of a number of carrier frequencies for performance of measurements by the wireless device,
a configuration for measurements on at least one reference signal,
a configuration for measurements on a type of reference signal,
a measurement or measurement type,
a procedure,
a characteristic of a signal or a measurement,
an activity or inactivity level,
a characteristic associated with a traffic level, and
a timing parameter.

48. A wireless device for transitioning between measurement gap patterns, MGPs, the wireless device adapted to:
detect a triggering event for transitioning from a first MGP to a second MGP;
in response to detecting the triggering event, cease to use a first set of properties associated with the first MGP and initiate use of a second set of properties associated with the second MGP; and
perform at least one task according to the second MGP based on the second set of properties.

49. The wireless device of claim 48, wherein:
the first MGP comprises a Predefined MGP, PMGP, and the second MGP comprises a normal MGP, NMGP, or
the first MGP comprises a NMGP and the second MGP comprises a Predefined MGP, PMGP.

50. The wireless device of claim 48, wherein at least one of the first set of properties and the second set of properties comprises a property or parameter associated with scheduling during measurement gaps.

51. The wireless device of claim 48, wherein at least one of the first set of properties and the second set of properties comprises any one or more of:
a property associated with a measurement gap length, MGL,
a property associated with a measurement gap repetition period, MGRP, and
a property associated with an offset.

52. The wireless device of claim 48, wherein when performing the at least one task the wireless device is adapted to perform at least one of:
performing at least one measurement during a measurement gap according to the second MGP, and
receiving scheduling during a measurement gap of the second MGP when the measurement gap is not used for measurements.

53. The wireless device of claim 48, wherein when detecting the triggering event for transitioning from the first MGP to the second MGP the wireless device is adapted to receive at least one message from a network node.

54. The wireless device of claim 53, wherein message comprises at least one of:
a configuration of a signal,
a measurement or measurement type,
a procedure,
a characteristic of a signal or a measurement,
an activity or inactivity level,
a characteristic associated with a traffic level, and
a timing parameter.

55. The wireless device of claim 48, wherein when detecting the triggering event for transitioning from the first MGP to the second MGP the wireless device is adapted to perform at least one of:
detecting a configuration for measurements in a radio access technology;
detecting a configuration or deconfiguration of a number of carrier frequencies for performance of measurements;
detecting a configuration for measurements on at least one reference signal; and
detecting a configuration for measurements on a type of reference signal.

56. A network node for assisting a wireless device in transitioning between measurement gap patterns, MGPs, the network node adapted to:
transmit a message to the wireless device to trigger the wireless device to cease using a first set of properties associated with a first MGP and initiate using of a second set of properties associated with a second MGP when transitioning from the first MGP to the second MGP.

57. The network node of claim 56, wherein:
the first MGP comprises a Predefined MGP, PMGP, and the second MGP comprises a normal MGP, NMGP, or
the first MGP comprises a NMGP and the second MGP comprises a PMGP.

58.-62. (canceled)
